(19) United States
(12) Patent Application Publication
(10) Pub. No.: US 2001/0052404 A1
(43) Pub. Date: Dec. 20, 2001

(54) Process for producing lead grids

(76) Inventors: Dr. Werner Nitsche, Lippstadt (DE); Dr. Hans Stumpf, Auerswalde (DE)

Correspondence Address: CANTOR COLBURN, LLP, 55 GRIFFIN ROAD SOUTH, BLOOMFIELD, CT, 06002

(21) Appl. No.: 09/488,234

(22) Filed: Jan. 20, 2000

(30) Foreign Application Priority Data
Jan. 21, 1999 (EP) 99100976.2

(51) Int. Cl. B22D 1/00; B22D 11/00; B23P 13/00

(52) U.S. Cl. 164/76.1; 29/2

(57) ABSTRACT

To provide a process for producing lead grids, with which the waste rate can be reduced, materials can be saved, volume corrosion can be largely eliminated or at least reduced and the geometric designs made can be expanded, a process is proposed for producing lead grids for lead electrodes to make storage batteries in continuous manufacture, wherein grid blanks are produced by pouring a material containing lead that can be hardened and then ausformed by rolling, with the addition of heat, at a temperature under the melting point.

This invention concerns a process for producing lead grids for lead electrodes for storage batteries.

Processes for producing lead grids in continuous manufacturing are known in and of themselves and are used to a great extent intensively. It is known how to produce molded parts in continuous processes, where an output nozzle (pouring nozzle) and the mold are moved in relation to one another so that the output nozzle fills the mold with liquid material which is hardened un the mold area and moved away from the output nozzle by relative movement, and synchronously with it, the hollow space in the mold, which is free again, is moved into the area near the output nozzle for continuous filling. This technology is commonly used to pour grid elements made of lead to produce lead electrodes in the manufacture of storage batteries. Because the material has the ability to flow, when it is put into the negative mold by the output nozzle, it has a tendency to spread out fast in the negative mold and especially to slip forward and fill the mold opposite the output nozzle, so that later in the mold-filling process, as a result of relative movement, liquid material is added that is already hardened, and no material or non-positive joint is formed here in the molded part. Molded parts with such defects cannot be used any more.

In the state of the art, it is known how to arrange sealing strips in the area near the output nozzle to prevent uncontrolled lead outflow; they basically project into the negative mold and prevent the mold from slipping forward out of control when it is filled with flowing material. However, there can be friction pairing between the mold and the sealing strips that can cause excessive material strain.

One proposal was to force the flowing material to change direction by molding the corners of the molded part to prevent forward slipping.

Processes are also known in which nitrogen (N₂) is blown into the nozzle area, so that no oxide film can form. But the forward flow of lead and the resultant cold-welding proved extremely disadvantageous. Moreover, when pasting with the active mass along the grain boundaries formed in the poured grids in which directed crystals stand, there is corrosion on the edges of the grains from the acids, so the grid breaks. Thus it cannot perform its function as either an electrical conductor or a carrier for the active masses.

There were also attempts made by so-called cold-rolling to break the grain boundaries so that no more directed crystals can be found on the surface there, but the structure could not be relaxed and has a high inner energy, so there is a high degree of so-called volume corrosion. Therefore the minimum thickness needed is in the range from 0.8 mm to 1 mm.

To prevent disadvantages based on cold-welding and corrosion on the edges of the grains, it has also been proposed already to make grids out of expanded metals. But they do not have closed frames and cannot be contoured. What is more, a lot of material is wasted in separating the plates.

In general, with the processes known from the state of the art, thin grids cannot be made, there are high rates of waste due to cold-welding and very narrow limits are set in terms of the geometric design of the grids and the individual areas of the grid.

Starting from the state of the art, the problem of this invention is to provide a process for producing lead grids in which the rate of waste can be reduced, materials can be saved, volume corrosion can be largely eliminated or at least reduced and geometric mold designs can be expanded.

For the technical solution to this problem, the invention proposes a process for producing lead grids for lead electrodes for making storage batteries in continuous manufacture, where by pouring a material containing lead that can be hardened, grid blanks can be made and then molded by rolling, with the addition of heat, at a temperature under the melting point.

The process in the invention has a substantial number of advantages. For one thing, the crystal structure can be flattened out, with simultaneous relaxation and complete recrystallization, hence decomposition of the inner energy, and cold-welding can be cured and different shapes and thicknesses can be made in different areas of the grid.

The new type of process assumes that heat is added in the range under the melting point, and a rolling process is used for ausforming a grid blank. This can be done continually. The mixture of materials usually contains lead, aluminum, calcium, tin, and sometimes silver as well. The melting point is roughly 300° Celsius. The preferred working range for the method in the invention is above the recrystallization temperature. After the rolling process, there is thus a completely recrystallized structure, which will not change any more if later influenced by heat.

The process in the invention can be used on several levels. For example, if the grid blank is made with an initial strength of 2 mm, it can be rolled in two phases to a thickness of 0.5 mm by rolling off roughly 50% of the thickness in each phase. The length will approximately double in each phase. One special advantage of the process consists of the fact that different areas can now be molded differently. Thus, for example, the lug can be made thicker than the grid.

Now the molding depends on the flow of material, so that for the first time, almost any shape lead grids for electrodes are possible, even three-dimensional ones.

The invention provides a very easy-to-use, extremely economical and very effective process for producing lead grids for electrode manufacture.

1. A process for producing lead grids for lead electrodes for storage batteries in continuous manufacture, wherein grid blanks are made by pouring a material containing lead that can be hardened and they are then molded by rolling, with the addition of heat, at a temperature under the melting point.

2. The process in claim 1, characterized by the fact that the molding takes place at a temperature above the recrystallization temperature >100° C.

3. The process in one of the preceding claims, characterized by the fact that the molding takes place at roughly 250° Celsius.

4. The process in one of the preceding claims, characterized by the fact that multiphase rolling processes run one after another.

5. The process in claim 4, characterized by the fact that two steps in the rolling process are carried out one after another.

6. The process in one of the preceding claims, characterized by the fact that that the grid blank is made with a material thickness of roughly 2 mm.

7. The process in one of the preceding claims, characterized by the fact that individual areas of the grid blank are halved in thickness and doubled in length in one rolling step.

8. The process in one of the preceding claims, characterized by the fact that the different degrees of ausforming are chosen in different areas of the grid blank.

9. The process in one of the preceding claims, characterized by the fact that the grid is rolled to a thickness of 0.5 mm.
